(19) United States
(12) Patent Application Publication
(10) Pub. No.: US 2007/0231145 A1
(43) Pub. Date: Oct. 4, 2007

(54) Multiple Fans of Cascade Connection

(75) Inventor: Motoi Jin, Gunma (JP)

Correspondence Address: BOYLE FREDRICKSON S.C., 840 North Plankinton Avenue, MILWAUKEE, WI, 53203, US

(73) Assignee: JAPAN SERVO CO., LTD., Gunma (JP)

(21) Appl. No.: 11/686,575

(22) Filed: Mar. 15, 2007

(30) Foreign Application Priority Data
Mar. 29, 2006 (JP) 90002/2006

(51) Int. Cl. B64C 11/00

(52) U.S. Cl. 416/198 R

(57) ABSTRACT

Multiple fans of cascade connection comprises at least two fans of cascade connection, and a commutation device arranged between the two fans. The commutation device is composed of a cylindrical case and a plurality of planar plates, each extending radially from the center axis of the cylindrical case to an inner peripheral wall of the cylindrical case, and extending axially in the cylindrical case. The two fans are connected coaxially and identical substantially in design with each other.

### BACKGROUND OF THE INVENTION

1. Field of the Invention

The present invention relates to fans of cascade connection, and more particularly, relates to multiple fans of cascade connection having a commutation device arranged between a fan of the upstream side and a fan of the downstream side.

2. Description of the Prior Art

An axial flow fan has been used as a cooling fan for the air conditioning devices, personal computers, servers or the like. The Japanese Patent Application Laid-Open No. 349476/2002 discloses fans of cascade connection comprising at least two axial flow fans which can increase the quantity of air flow for use in such a case that the flow resistance of air passage is large.

It is desirable that the maximum air speed of the fans of cascade connection is equal to that of one fan and that the hydrostatic pressure of the fans of the cascade connection is about 2 times larger than that of one fan. However, the hydrostatic pressure of the conventional fans of cascade connection is about 1.5 times larger than that of one fan. The hydrostatic pressure of the fans of cascade connection having stationary blades is about 1.8 times larger than that of one fan. In the fans of cascade connection, fans are rotated in the same direction with one another and accordingly a revolving current component is included in the velocity component of air flow directed from the upstream side fan to the downstream side fan, and an air flow having the revolving current component of a direction similar to the rotary direction of the downstream side fan is entered into the downstream side fan, so that the relative rotary speed of the downstream side fan becomes small, and the ability of the fans of cascade connection becomes lowered.

### SUMMARY OF THE INVENTION

An object of the present invention is to obviate the above defects.

The above object can be accomplished by multiple fans of cascade connection comprising at least two fans of cascade connection, and a commutation device arranged between the two fans, the commutation device being composed of a cylindrical case and a plurality of planar plates, each extending radially from the center axis of the cylindrical case to an inner peripheral wall of the cylindrical case, and extending axially in the cylindrical case. These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 is a vertically sectional side view of fans of cascade connection of the present invention with a portion being cut away.

FIG. 2 is a front view of the fans shown in FIG. 1.

FIG. 3 is a front view of a commutation device in the fans of cascade connection of the present invention.

FIG. 4 is a perspective view of the commutation device of FIG. 3.

### DETAILED DESCRIPTION OF THE PREFERRED EMBODIMENTS

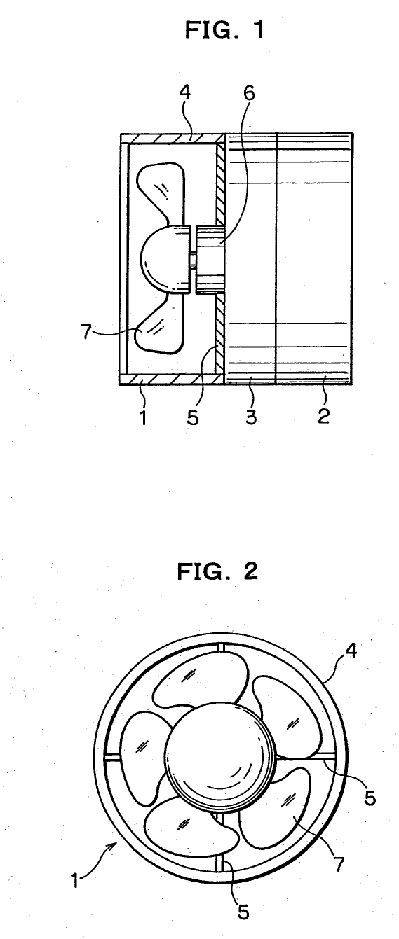

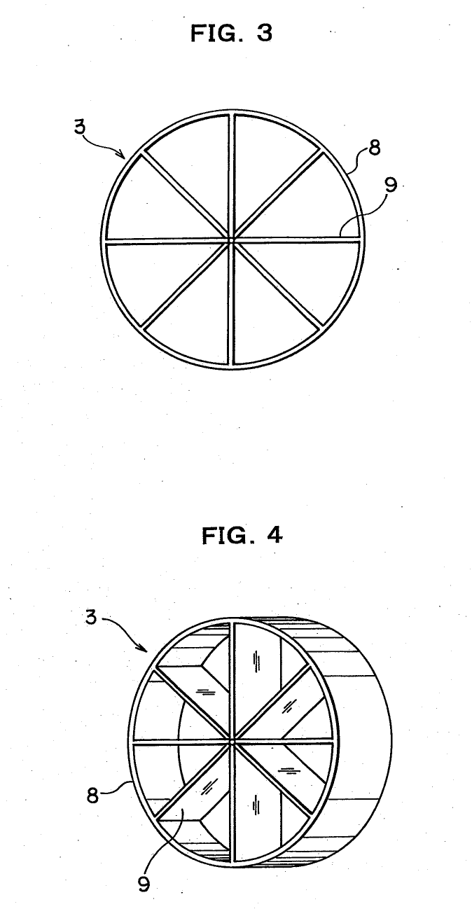

As shown in FIG. 1 and FIG. 2, fans of cascade connection of the present invention comprises a fan 1 of upstream side and a fan 2 of downstream side, both being identical in design with each other and connected coaxially with each other, and a commutation device 3 inserted between the fans 1 and 2.

Each of the fan 1 of the upstream side and the fan 2 of the downstream side comprises a cylindrical case 4, a motor 6 arranged in the cylindrical case 4 and fixed thereto by a supporting member 5, and a moving blade 7, as shown in FIG. 1 and FIG. 2.

The commutation device 3 comprises a cylindrical case 8 similar substantially in diameter to the cylindrical case 4, and a plurality of planar commutation plates 9 arranged axial symmetrically in the cylindrical case 8 so as to extend in the radial direction from the center of the cylindrical case 8 to the inner peripheral wall of the cylindrical case 8, and to extend axially in the cylindrical case 8.

In the fans of cascade connection of the present invention, the dynamical pressure in the revolving current component of the air flow from the fan 1 of the upstream side is changed to the elevated hydrostatic pressure by the commutation device 3, so that the revolving current component of the air flow received by the fan 2 of the downstream side is reduced. Accordingly, the ability of the downstream side fan 2 is prevented from being reduced, and the noise of the fan is reduced.

Further, the pressure interference area of the moving blade 7 can be reduced, because the commutation plates 9 of the commutation device 3 are arranged axial symmetrically.

The commutation device 3 can be manufactured by the injection mold in low cost.

The effect of the multiple fans of cascade connection having the commutation device 3 of the present invention is recognized even in the fans, each having a cylindrical case 8 of about 1 inch in length. The effect can be increased by increasing the length of the cylindrical case 8.

While the invention has been particularly shown and described with reference to the preferred embodiments thereof, it will be understood by those skilled in the art that various changes in form and details may be made therein without departing from the spirit and scope of the invention as defined by the appended claims.

What is claimed is:

1. Multiple fans of cascade connection comprising at least two fans of cascade connection, and a commutation device arranged between the two fans, the commutation device being composed of a cylindrical case and a plurality of planar plates, each extending radially from the center axis of the cylindrical case to an inner peripheral wall of the cylindrical case, and extending axially in the cylindrical case.

2. The multiple fans of cascade connection as claimed in claim 1, wherein the two fans are connected coaxially and identical substantially in design with each other.

3. A cascaded fan assembly, comprising:
at least two fans connected to one another in a cascade fashion; and
a commutation device arranged between the two fans, the commutation device including a cylindrical case and a plurality of planar plates, each 1) extending radially from a center axis of the cylindrical case to an inner peripheral wall of the cylindrical case, and 2) extending axially in the cylindrical case.

4. The cascaded fan assembly as claimed in claim 3, wherein the two fans are connected coaxially and are at least substantially identical to each other.

5. The cascaded fan assembly claimed in claim 3, wherein the commutation device changes a dynamical pressure in a revolving current component of the air flow from a fan on an upstream side of the assembly to an elevated hydrostatic pressure so that a revolving current component of the air flow received by a downstream fan of the assembly is reduced, thereby reducing fan noise.
